(19) United States
(12) Patent Application Publication
(10) Pub. No.: US 2012/0279506 A1
(43) Pub. Date: Nov. 8, 2012

(54) MOUTHGUARD WITH IMPACT GAP

(76) Inventors: Michael C. Thompson, Southern Pines, NC (US); Yung C. Chen, Yung-Kang (TW)

(21) Appl. No.: 13/462,501

(22) Filed: May 2, 2012

Related U.S. Application Data
(60) Provisional application No. 61/518,144, filed on May 2, 2011.

(51) Int. Cl. A61C 5/14

(52) U.S. Cl. 128/861

(57) ABSTRACT

A mouthguard includes an integrally molded tray having upper and lower portions joined by a hinge along an inner portion of the tray that defines an open-sided channel gap between the upper and lower tray portions. Shock forces tending to deflect the lower portion of the tray toward the upper portion are countered by a moment resistance of the hinge as the channel gap between the upper and lower tray portions closes. Additional energy absorption is provided by a cushion liner attached to an inner surface of the tray that prevents contact between the upper and lower tray portions, as well as an air cell defined by an occlusal pad attached to the lower tray portion. Embodiments include a detachable tether that is received within a tether mount incorporated within the mouthguard.

### CROSS-REFERENCE TO RELATED APPLICATIONS

The present application claims priority to U.S. Provisional Patent Application No. 61/518,144 filed May 2, 2011, the disclosure of which is hereby incorporated by reference in its entirety.

### BACKGROUND

Protective devices for the mouth are commonly used in sports or other activities where deliberate or accidental impact to a user's face or jaw may cause harm. For example, mouthguards are used by athletes of various sports such as baseball, football, hockey, equestrian sports, boxing, martial arts, lacrosse, rugby, and wrestling to protect or stabilize the user's lower jaw and teeth in relation to the user's upper jaw and teeth in addition to minimizing damage to nearby soft tissue.

Current existing protective devices for the mouth, in particular mouthguards, utilize various methods of absorbing or dissipating forces from impact. Some of these methods include flexure of the structural frame of the device under stress, compression of energy absorbing materials, and use of voids in the material to dissipate energy. A mouthguard with a flexible hinge along an inner perimeter of the mouthguard to provide resistance when a moment force is exerted on it to provide protection against impact energy does not exist.

It is with respect to these and other considerations that the present invention has been made.

### SUMMARY

The above and other problems are solved by providing a mouthguard comprising a tray formed such that when external forces of impact or stress generated from a user's voluntary or involuntary muscle activity is translated across an occlusal area of the mouthguard, a flexible hinge is stressed with a moment force and absorbs impact energy through deflection from compressive closure of an open sided channel gap between an upper and lower portion of the tray.

According to embodiments, the mouthguard comprises a cushion liner attached to an inner surface of the tray designed to provide both an added moment resistance at the hinge as well as absorb compressive forces when the lower tray portion is deflected a sufficient distance equal to or greater than a height of the channel gap.

According to embodiments, the mouthguard comprises one or more occlusal pads attached to a bottom surface of the lower tray portion. The one or more occlusal pads define an air cell between the occlusal pad and the bottom surface of the lower tray portion to provide a deflection zone to help dissipate impact forces.

Embodiments include a detachable tether that is received within a tether mount incorporated within the mouthguard. The tether mount is comprised of a tether port formed into the lower tray portion and includes an anchor surface along the interior wall of the tether port designed to engage and retain the tether.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

FIG. 1 is an isometric view of a mouthguard according to an embodiment and illustrating upper and lower tray portions connected by an integral hinge;

FIG. 2 is a front elevation view of the mouthguard of FIG. 1 showing depth and height of a gap between a lower and upper tray;

FIG. 3A is a bottom view of the mouthguard showing the bottom side of the lower tray portion according to a first embodiment;

FIG. 3B is a bottom view of the mouthguard showing the bottom side of the lower tray portion and including an occlusal pad according to a second embodiment;

FIG. 4 is a side view of the mouthguard shown in FIG. 1;

FIG. 5 is a cross section view taken along line 5-5 in FIG. 3B;

FIG. 6 is a top view of a detachable tether that is received within a tether mount incorporated within the mouthguard;

FIG. 7 is an enlarged view of the detachable tether and a first embodiment of a tether mount incorporated within the mouthguard shown in FIG. 1;

FIG. 8 is an enlarged view of the detachable tether and a second embodiment of a tether mount incorporated within the mouthguard;

FIG. 9 is a section view taken along line 9-9 in FIG. 7; and

FIG. 10 is a section view taken along line 10-10 in FIG. 8.

### DETAILED DESCRIPTION

Embodiments of the present invention are directed to a mouthguard having an integrally molded tray that is structurally hinged along an inside perimeter of the tray to define a channel gap open along an outside perimeter of tray. In the event the mouthguard undergoes impact forces, the flexible hinge absorbs impact energy through deflection from compressive closure of the channel gap.

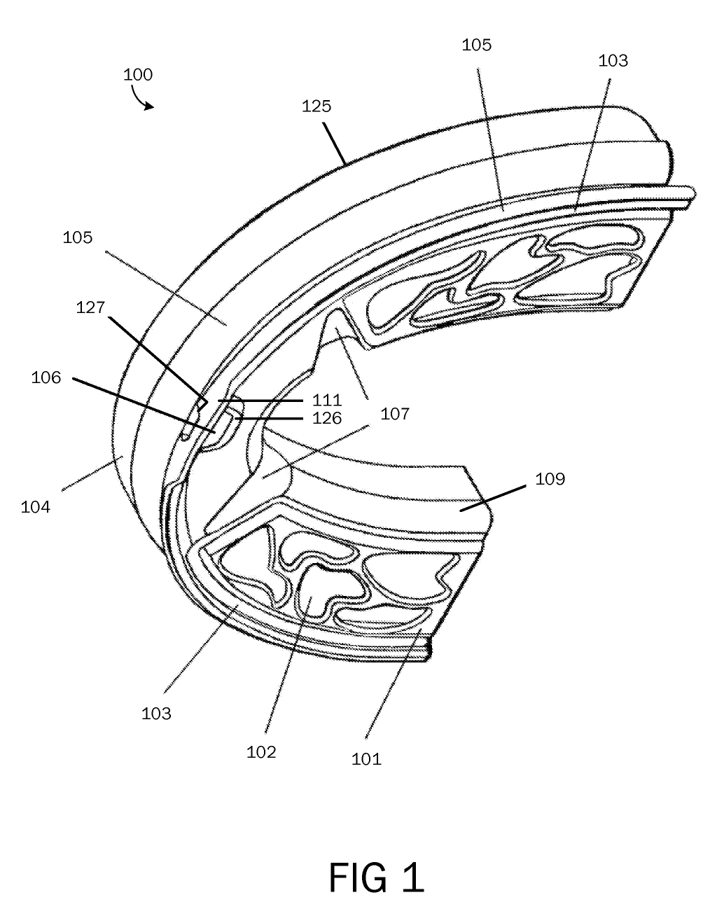

An isometric view of the mouthguard is illustrated in FIG. 1. According to embodiments and as shown in FIG. 1, the mouthguard 100 is generally u-shaped and comprises an integrally molded tray 125 shaped such that an upper tray portion 104 and a lower tray portion 103 are structurally connected by a flexible hinge portion 109 along an inner perimeter of the tray.

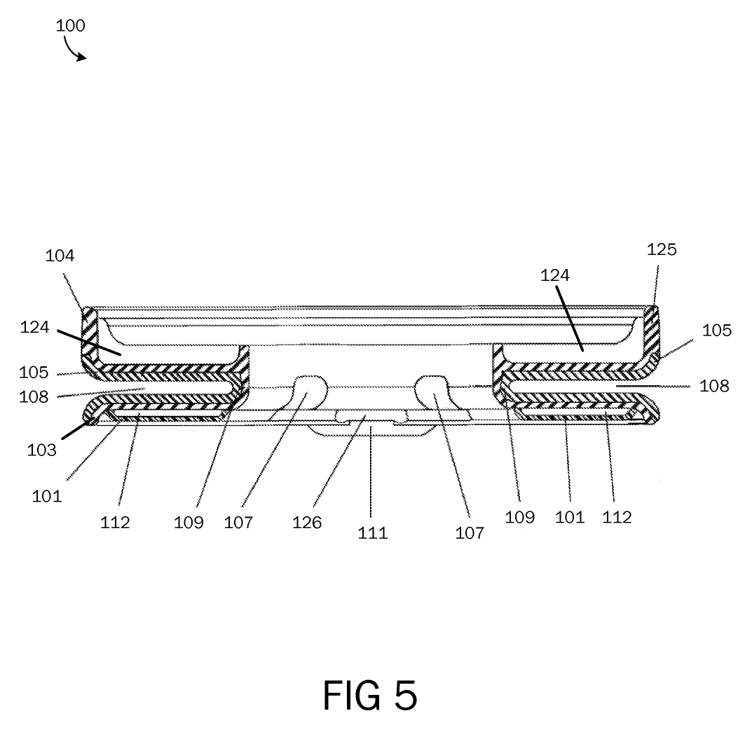

As best shown in the cross section view FIG. 5, the upper tray portion 104 defines an upwardly facing u-shaped channel shaped to receive a user's upper teeth. According to an embodiment, a deformable liner 124 is attached to the upper tray portion 104 disposed inside the u-shaped channel defined by the upper tray portion. When the mouthguard 100 is worn by a user, the deformable liner 124 is designed to have occlusal contact with the user's upper teeth.

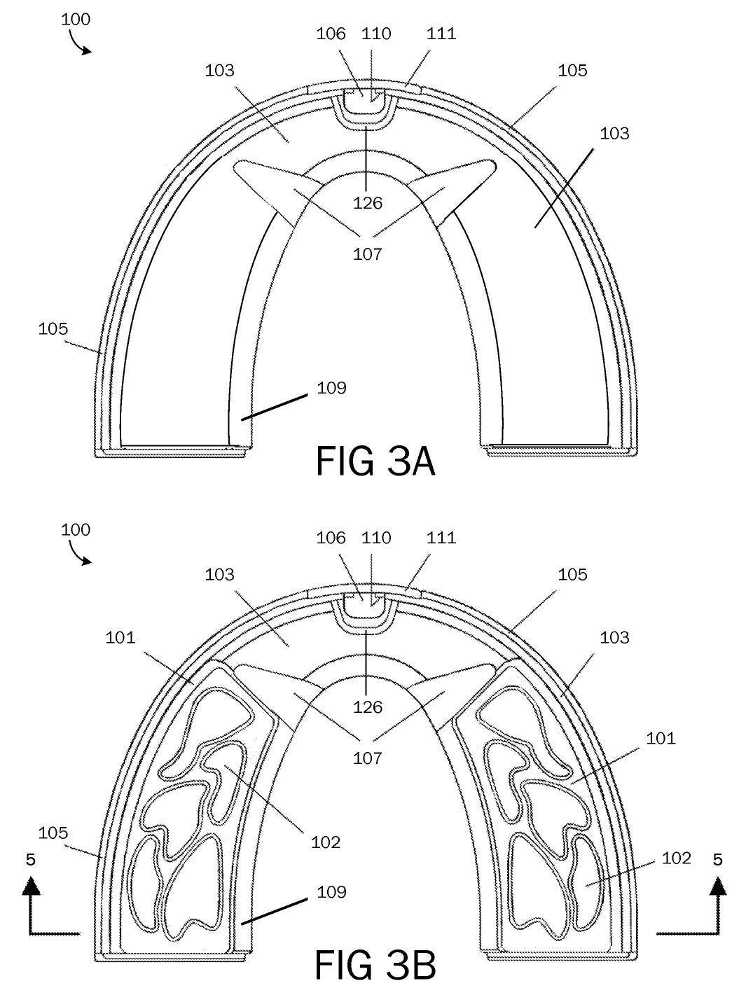

According to one embodiment and as best shown in FIG. 3A, the downwardly facing surface of the lower tray portion 103 is generally u-shaped and adapted to have occlusal contact with a user's bottom teeth.

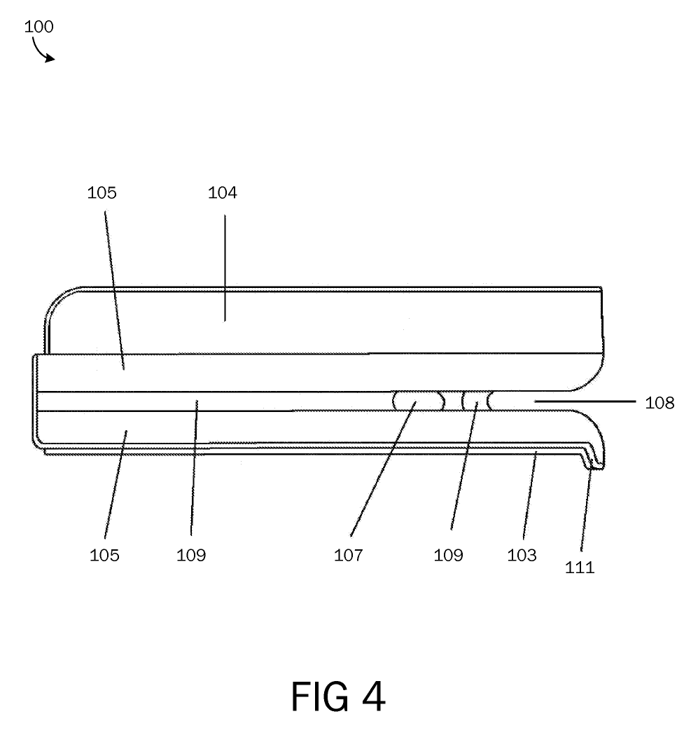

As shown in FIGS. 1-5, a flexible cushion liner 105 is attached to an inner surface of the tray 125, covering the downwardly facing surface of the upper tray portion 104, the inner radius of the hinge portion 109, and the upwardly facing surface of the lower tray portion 103. The cushion liner 105 is preferably made of a material that is not permanently deformed after it is compressed. According to a first embodiment, the cushion liner 105 is designed to absorb compressive forces when the lower tray portion 103 is deflected a sufficient distance equal to or greater than a height of a channel gap 108 formed between the upper tray portion 104 and the lower tray portion 103. For example, deflection of the lower tray portion 103 towards the upper tray portion may occur when a user's jaw closes from impact forces. According to a second embodiment, the cushion liner 105 extends to the hinge portion 109 (thus enhancing the thickness of the hinge), and thereby augmenting the moment resistance provided by the hinge 109.

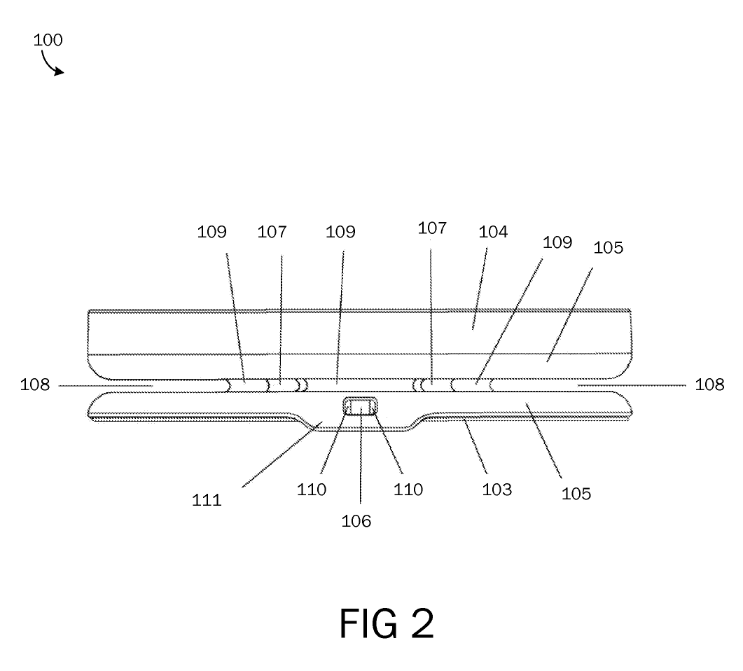

As best shown in FIGS. 2, 4 and 5, the integrally molded tray 125 is shaped such that the channel gap 108 is formed between the upper tray portion 104 and the lower tray portion 103. The cushion liner 105 described above may be manufactured with varying thicknesses, providing for a variety of channel gap 108 heights.

Referring still to FIGS. 2, 4, and 5, the upper tray portion 104 and the lower tray portion 103 are joined together and cantilevered by the hinge portion 109. The hinge portion 109 is elastic and structurally formed such that when a force of impact or stress is applied upwardly to the downwardly facing surface of the lower tray portion 103 (or a force is applied downwardly to the upwardly facing surface of the upper tray portion 104), the hinge portion 109 absorbs energy through deflection from closure of the channel gap 108. The height of the channel gap 108 provides a travel distance for deflection of the upper tray portion 104 and lower tray portion 103. When force is applied to the upper 104 and lower 103 tray portions, the hinge portion 109 is stressed with a moment force. The hinge portion 109 of the integrally molded tray 125 (as well as the hinge portion 109 of the cushion liner 105) provides a moment resistance from the compressive load between the upper 104 and lower 103 tray portions. The thickness of the hinge portion 109 may be varied, as well as the materials used, to customize the amount of resistance and thus energy absorption provided.

While the hinge 109 is preferably a living hinge formed as part of the integral tray 125, in another embodiment the upper 104 and lower 103 tray portions may comprise separate elements that are structurally joined together by a separate hinge 109 to maintain the channel gap 108.

According to an embodiment and as shown in FIGS. 1-5, airways 107 may be formed through the radius of the hinge portion 109 and the downwardly facing surface of the lower tray portion 103. The airways 107 allow for flow of breathing air, for example, during athletic exercise. The size of the airways 107 defined by the hinge portion 109 are designed to allow adequate breathing air for demanding athletic activities while allowing adequate length of the hinge portion 109 around the inner radius of the tray 125 to structurally resist the moment force exerted on it during compression of the upper tray portion 104 and the lower tray portion 103.

According to an embodiment and as best shown in FIG. 3B, one or more occlusal pads 101 are attached to or formed integrally with the downwardly facing surface of the lower tray portion 103. A bottom surface of the one or more occlusal pads 101 is adapted to receive occlusal contact with a user's bottom teeth. As best shown in FIG. 5, the occlusal pads 101 define air cells 112 between the occlusal pads 101 and the downwardly facing surface of the lower tray portion 103 to provide a cushion or deflection zone to help dissipate impact forces. If the impact force is great enough that it expends the available shock absorption of the air cells 112, the force is transmitted to the lower tray portion 103 of the mouthguard 100. Thus, the strain travel or deflection of the air cells 112 provides additional energy absorption beyond that provided by the moment resistance of the hinge portion 109 and the moment resistance and the compressive resistance of the cushion liner 105. According to an embodiment and as best shown in FIGS. 1 and 3B, the occlusal pads 101 include a plurality of penetrations 102 that provide a decorative pattern and function to provide a better gripping surface for a user's bottom teeth.

According to an embodiment and as shown in FIGS. 1-5, the mouthguard 100 may comprise a shield 111 attached to or formed integrally with the tray 125. As best shown in the cross section view of FIG. 5, the shield 111 protrudes below the lower tray portion 103 and is designed to protect a user's teeth from frontal impact. The height of the shield 111 below the lower tray portion 103 provides a limit to the insertion of the mouthguard 100 into the user's mouth.

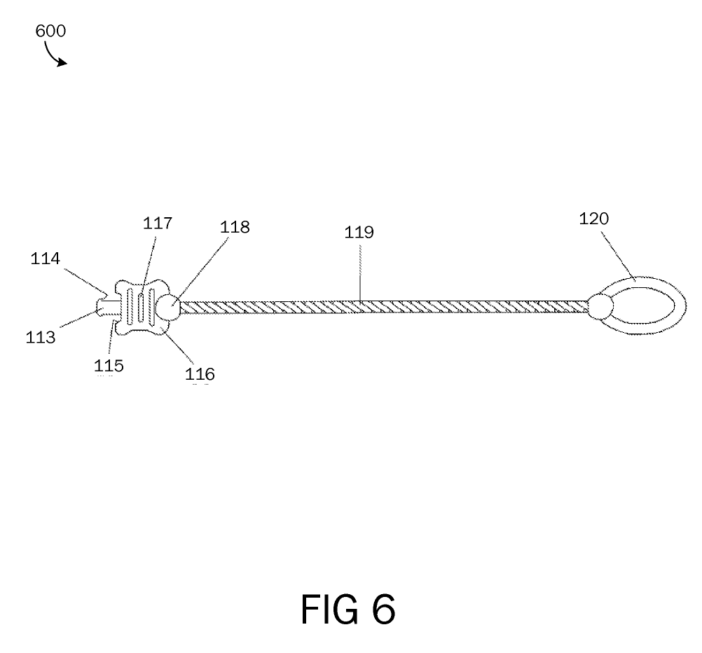

In some use cases, such as in high impact athletic activities where a user wears a helmet or other type of head protection device, it is desirable to selectively attach or tether the mouthguard 100 to the helmet. Embodiments of the present invention include a detachable tether 600 and alternative embodiments of a tether mount incorporated within the mouthguard 100 adapted to selectively engage the tether 600. The tether 600 comprises a lanyard 119 and a mounting ring 120 disposed at an end of the lanyard 119 as is shown in FIG. 6. The tether 600 is adapted for selective attachment to and selective detachment from a helmet by looping the lanyard 119 around a bar on the faceguard of the helmet and passing it through the mounting ring 120. The probe 113 is disposed on the opposite end of the lanyard 119 and is adapted to be selectively received and released from the tether mount incorporated within the mouthguard 100.

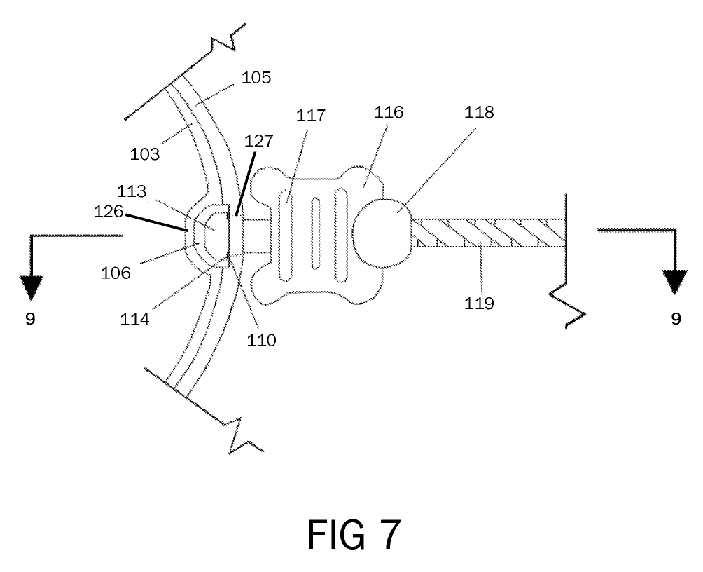

The first embodiment of the tether mount is shown in FIGS. 1-5 and 7. According to the first embodiment, the tether mount is formed within the mouthguard 100 and includes a tether port 106 and an anchor surface 110. As best shown in FIGS. 1, 2, 3A, 3B, 5, and 7, the tether port 106 is a cavity defined by an inward protrusion 126 of the lower tray portion 103 and an orifice 127 formed through the cushion liner 105 through which a probe 113 disposed on an end of the tether 600 may be inserted. As best shown in FIG. 7, the orifice 127 is formed through the cushion liner 105 such that the width of the orifice 127 is less than the width of the tether port 106, thereby defining the anchor surface 110 along the interior wall of the cushion liner 105 inside the tether port 106. The anchor surface 110 is designed to provide a land for a portion of the tether probe 113 that engages and retains the tether 600 after the probe 113 has been inserted through the orifice 127.

An anchor barb 114 is formed on the end of the probe 113. As best shown in FIG. 7, when the probe 113 is inserted into the tether port 106, the anchor barb 114 is designed to deflect inward sufficiently to pass through the orifice 127. In particular, the anchor barb 114 is designed so that once the end of the deflected anchor barb 114 passes through the orifice 127 and past the anchor surface 110, it springs back to its original configuration so that a flat rear portion of the anchor barb 114 is parallel with the anchor surface 110. The anchor surface 110 provides axial structural restraint for the tether 600 when the probe 113 is inserted. When the tether 600 is pulled away from the mouthguard 100, the anchor barb 114 and the anchor surface 110 engage to provide a limited resistance. The resistance force is obtained from deflection of the anchor barb 114 under tensile load of the tether 600. A sufficiently great force provides sufficient deflection to allow the anchor barb 114 to disengage from the anchor surface 110 and pass through the orifice 127 to remove the tether 600 from the mouthguard 100. According to one embodiment, the tether probe 113 includes two anchor barbs 114 extending outward from the lateral sides of the probe 113. According to another embodiment, the anchor barb 114 may be rounded with an outer diameter greater than the diameter of the orifice 127. The design of the anchor barb 114 and materials of construction allow a variance in the tensile force required to withdraw the tether 600.

As best illustrated in FIGS. 6 and 7, a lip rest tab 116 and knob 118 are disposed between the tether probe 113 and the lanyard 119. The lip rest tab 116 is provided as a lip rest for a user during use and as a grip for withdrawal of the tether 600 from the mouthguard 100. The lip rest tab 116 comprises a tab gripping surface 117 covering at least a portion of the tab 116. The tab gripping surface 117 and the knob 118 are provided as an additional gripping surface to aid a user in obtaining an adequate grip to withdraw the tether 600 from the mouthguard 100.

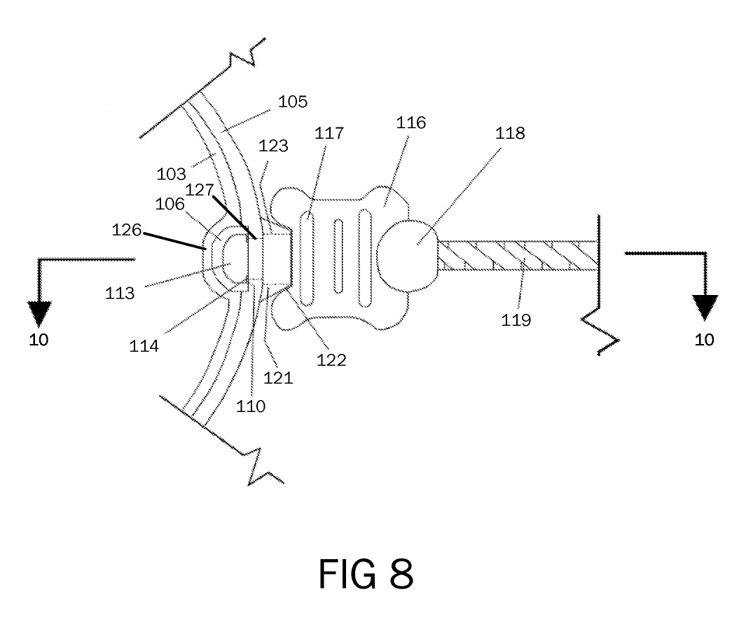

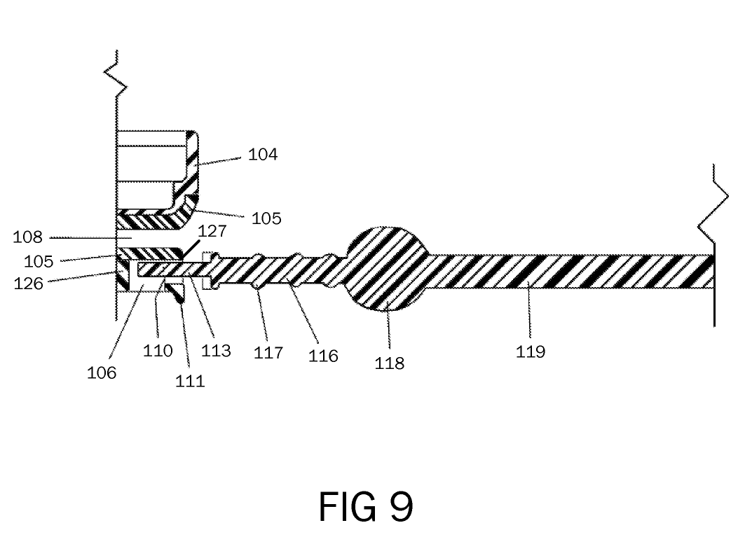

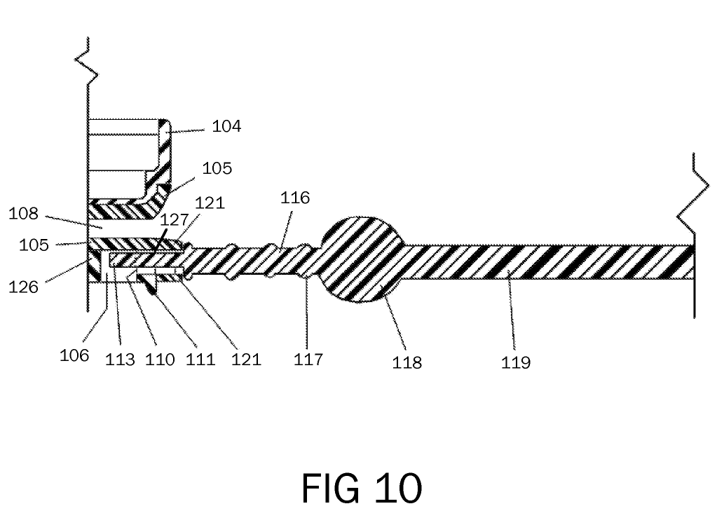

The second embodiment of the tether mount is shown in FIGS. 8 and 10. The second embodiment is similar to the tether mount of the first embodiment with the inclusion of a lateral brace 121. The lateral brace 121 is attached to or formed integrally with the lower tray portion 103. A tether port tunnel 123 formed through the lateral brace 121 provides a tunnel to the tether port 106 through which the tether probe 113 may pass when attaching the tether 600 to the mouthguard 100. The inner diameter of the tether port tunnel 123 is greater than the diameter of the orifice 127 to allow for unimpeded passage of the anchor barb 114 within the tether port tunnel 123 until the anchor barb 114 passes through the orifice 127 and engages the anchor surface 110. As shown in FIG. 9, the unsupported distance between the cushion liner 105 and the lip rest tab 116 of the first embodiment of the tether mount may allow for easy lateral motion of the tether 600 in relation to the mouthguard 100, whereas, as shown in FIG. 10, the lateral brace 121 of the second embodiment of the tether mount provides lateral support for the tether 600 between the cushion liner 105 and the lip rest tab 116. A lateral contact plane 122 is provided on the lip rest tab 116 wherein lateral forces may be transferred between the lateral brace 121 and the lip rest tab 116 to provide a more secure attachment of the tether 600 to the mouthguard 100 than the first embodiment mount. The second embodiment mount provides a higher resistance against lateral forces from the tether 600 and thus helps prevent inadvertent detachment of the tether 600 from the mouthguard 100 from unintentional lateral forces.

The materials that comprise the majority of the mouthguard 100 and tether 600 are preferably a soft plastic. For example, the tray 125 may be made of a thermoplastic elastomer configured by injection molding. Differing types of plastic can be utilized to feed functional requirements such as structural durability and wear consideration. One example is to use a plastic or latex for use as the cushion liner 105, Ethylene Vinyl Acetate (EVA) for use as the deformable liner 124, and Polypropylene (PP) for use as the occlusal pad 101. The materials that comprise the tether 600 are preferably flexible materials such as polyurethane or the like. Other materials may be used that fulfill structural, durability, economical and other requirements for use as a mouthguard.

The various embodiments described above are provided by way of illustration only and should not be construed as limiting. While the disclosed invention has been described with reference to various embodiments, it will be understood to those skilled in the art that various changes may be made and equal elements may be substituted for elements thereof without departing from the scope of the present invention. The scope of the present invention further includes any combination of the elements from embodiments as set forth herein. In addition, modification may be made to adapt the teaching of the present invention to a particular application without departing from its essential scope thereof.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is intended that the invention not be limited to the particular embodiments described and/or illustrated, but that the invention will include all embodiments falling within the scope of the appended claims.

What is claimed:

1. A mouthguard comprising an integrally molded tray, the tray including:
an upper tray portion adapted to receive a user's upper teeth;
a lower tray portion adapted to receive a user's bottom teeth; and
a hinge portion disposed along an inner perimeter of the tray operative to:
structurally connect the upper tray portion and the lower tray portion;
define a channel gap between the upper tray portion and the lower tray portion; and
resist deflection of the lower tray portion toward the upper tray portion.

2. The mouthguard of claim 1 further comprising:
a cushion liner attached along an inner surface of the upper tray portion and an opposing inner surface of the lower tray portion to absorb compressive forces when the lower tray portion is deflected a sufficient distance equal to or greater than a height of the channel gap.

3. The mouthguard of claim 2, wherein the cushion liner is further attached along an inner surface of the hinge portion of the tray to augment the hinge portion and further resist deflection of the lower tray portion toward the upper tray portion.

4. The mouthguard of claim 2, further comprising one or more occlusal pads disposed along a downwardly facing surface of the lower tray portion and defining air cells between the occlusal pads and the lower tray portion, wherein the occlusal pads are adapted to receive occlusal contact with a user's bottom teeth and the occlusal pad air cells are operative to absorb impact energy imparted to the occlusal pads.

5. The mouthguard of claim 4, wherein the one or more occlusal pads define a plurality of penetrations to provide a better gripping surface for a user's bottom teeth.

6. The mouthguard of claim 2, wherein:
an inward protrusion of the lower tray portion defines a tether port adapted to receive a probe portion of a tether; and
the cushion liner defines an orifice adapted to allow passage of the probe portion through the cushion liner and into the tether port defined in the lower tray portion, wherein an inner wall of the cushion liner further defines an anchor surface operative to engage an anchor barb formed on an end of the tether probe portion.

7. The mouthguard of claim 1, wherein the hinge portion and the lower tray portion define airways to allow breathing air to flow through the mouthguard.

8. A mouthguard comprising:
an upper tray adapted to receive a user's upper teeth;
a lower tray including one or more occlusal pads attached along a downwardly facing surface of the lower tray and defining air cells between the occlusal pads and the lower tray, wherein the occlusal pads are adapted to receive occlusal contact with a user's bottom teeth and the occlusal pad air cells are operative to absorb impact energy imparted to the occlusal pads; and
a hinge connecting an inner perimeter of the upper and lower trays, the hinge operative to:
define a channel gap between the upper tray and the lower tray; and
resist deflection of the lower tray toward the upper tray.

9. The mouthguard of claim 8, wherein the one or more occlusal pads define a plurality of penetrations to provide a better gripping surface for a user's bottom teeth.

10. The mouthguard of claim 9, further comprising:
a cushion liner attached along an inner surface of the upper tray and an opposing inner surface of the lower tray to absorb compressive forces when the lower tray is deflected a sufficient distance equal to or greater than a height of the channel gap.

11. The mouthguard of claim 10, wherein the cushion liner is further attached along an inner surface of the hinge to augment the hinge and further resist deflection of the lower tray toward the upper tray.

12. The mouthguard of claim 11, wherein:
an inward protrusion of the lower tray defines a tether port adapted to receive a probe portion of a tether; and
the cushion liner defines an orifice adapted to allow passage of the probe portion through the cushion liner and into the tether port defined in the lower tray, wherein an inner wall of the cushion liner further defines an anchor surface operative to engage an anchor barb formed on an end of the tether probe portion.

13. A mouthguard with a detachable tether comprising:
a tether comprising a probe disposed on an end of the tether and one or more anchor barbs formed on an end of the probe;
an integrally molded tray, the tray including:
an upper tray portion adapted to receive a user's upper teeth;
a lower tray portion adapted to receive a user's bottom teeth, wherein the lower tray includes an inward protrusion defining a tether port to receive the probe of the tether; and
a hinge portion disposed along an inner perimeter of the tray operative to:
structurally connect the upper tray portion and the lower tray portion;
define a channel gap between the upper tray portion and the lower tray portion; and
resist deflection of the lower tray portion toward the upper tray portion; and
a cushion liner attached along an inner surface of the upper tray portion and an opposing inner surface of the lower tray portion to absorb compressive forces when the lower tray portion is deflected a sufficient distance equal to or greater than a height of the channel gap, the cushion liner defining an orifice to allow passage of the probe through the cushion liner and into the tether port defined in the lower tray portion, wherein an inner wall of the cushion liner further defines an anchor surface that engages the one or more anchor barbs of the tether to releasably attach the tether to the mouthguard.

14. The mouthguard with a detachable tether of claim 13, wherein the tether further comprises:
a lanyard and a mounting ring disposed at an end of the lanyard for selective attachment of the tether to a helmet; and
a lip rest tab disposed between the probe and the lanyard to provide a lip rest for a user during use and a grip for withdrawal of the tether from the mouthguard.

15. The mouthguard with a detachable tether of claim 14, further comprising a lateral brace disposed along an outer perimeter of the lower tray portion, the lateral brace defining a tether port tunnel that communicates with the tether port and allows passage of the probe into the tether port, the lateral brace providing a resistance from lateral movement of the tether.

16. The mouthguard with a detachable tether of claim 15, wherein a lateral contact plane disposed along an edge of the lip rest tab is operative to engage the lateral brace and limit lateral movement of the tether.

17. The mouthguard with a detachable tether of claim 13, further comprising one or more occlusal pads disposed along a downwardly facing surface of the lower tray portion and defining air cells between the occlusal pads and the lower tray portion, wherein the occlusal pads are adapted to receive occlusal contact with a user's bottom teeth and the occlusal pad air cells are operative to absorb impact energy imparted to the occlusal pads.

18. The mouthguard with a detachable tether of claim 17, wherein the one or more occlusal pads define a plurality of penetrations to provide a better gripping surface for a user's bottom teeth.

19. The mouthguard with a detachable tether of claim 13, wherein the hinge portion and the lower tray portion define airways to allow breathing air to flow through the mouthguard.

20. The mouthguard with a detachable tether of claim 13, further comprising a deformable liner disposed inside a channel defined by the upper tray portion, the deformable liner designed to have occlusal contact with a user's upper teeth.
